(19) United States
(12) Patent Application Publication
(10) Pub. No.: US 2009/0179414 A1
(43) Pub. Date: Jul. 16, 2009

(54) Protective book cover for a paperback type book

(76) Inventors: Sharon Nevitt, Nipomo, CA (US); Janine Penaflor, Nipomo, CA (US)

Correspondence Address: PATENT LAW & VENTURE GROUP, 2424 S.E. BRISTOL, SUITE 300, NEWPORT BEACH, CA, 92660, US

(21) Appl. No.: 12/009,303

(22) Filed: Jan. 16, 2008

(51) Int. Cl. B42D 3/00

(52) U.S. Cl. 281/34

(57) ABSTRACT

A protective covering for a paperback book provides a generally rectangular, foldable, protective sheet divided into a plurality of linearly adjoining panels. These panels include a front flap panel, a front cover panel, a spine panel, a rear cover panel, and a rear flap panel. Preferably each one of the adjacent panels is separated by at least one scoring line, allowing the panels to be easily and selectively folded around the outside of a paperback book. Adhesive portions are engaged with each one of the flap panels as well as the spine panel, each adhesive portion preferably providing a low-tack, reusable adhesive that enabling the protective covering to be easily attached and removed without leaving marks or residue on the book.

### BACKGROUND OF THE INVENTION

1. Field of the Present Disclosure

This disclosure relates generally to book coverings, and in particular, relates to a pre-scored sheet of foldable, protective material removably secured to the original cover of a paperback book without adding significant bulk to the book.

2. Description of Related Art Including Information Disclosed Under 37 CFR 1.97 and 1.98

Brody, U.S. Pat. No. 3,080,178, discloses a book covering comprising a transparent facing adapted to be applied to and to engage the longitudinal edges of a paper book jacket so as to provide a protective transparent cover for the embellished outer face of said book jacket, said facing having opposite longitudinal marginal edges, and adhesive tapes attached along portions only of their widths to and along the entire lengths of the longitudinal margins of said facing, the longitudinal axes of said tapes being parallel to said longitudinal marginal edges, and said tapes having free projecting flap portions being coated on one face with pressure-sensitive adhesive material, and said flap portions being free of attachment with said facing so as to be adapted for adhesive attachment to the covers of a book when said facing with its enclosed book jacket is wrapped around the book.

Holmes, U.S. Pat. No. 4,519,630, discloses an inexpensive but durable book cover which enables hard cover books to be provided at a substantially decreased cost with respect to conventional hard cover books. The binder comprises cover members comprising overlying panels which are joined to provide pockets in which may be received the cover of a paperback book and a spine hinged to the cover members through fold lines. The interiors of the pockets are embossed to aid in the insertion of the paperback book covers.

Carter et al., U.S. Pat. No. 4,527,814, discloses protective covers for books having two cover sections and pockets for receiving book covers, locking flaps for locking the protective covers to the book covers, an adjustable spine section to accommodate books of different thicknesses, and a tear-away strip to hold together the two cover sections until they are ready for use.

Dupuis, U.S. Pat. No. 4,819,964, discloses a combination book jacket cover removably secured to a book via transparent jacket-tapes to project the book and to prevent the book's hard covers from pulling out of the jacket cover's end flaps upon the book's back or spine being flexed, or from sliding up or down, thereby preventing tear or damage of the jacket cover, or damage to the book's hard covers and back. The jacket-tapes have adhesively coated end portions that are removably engaged with corresponding top and bottom portions of the jacket cover and end flaps.

Ducorday, U.S. Pat. No. 4,886,299, discloses a protective book cover of transparent plastic formed with a strengthened spine section provided by a combination of a spine reinforcing strip and decreased height of the spine section of the protective cover. The book cover receiving pockets of the protective cover are formed with inwardly convex slant-cut edges to facilitate insertion of the book covers, and a card pocket is formed in one of the pockets by a slant-cut slit that is convex upwardly to provide an easily accessible opening. A heat weld seam forming the front and back cover pockets is provided with sharp rectangular inside corners for a closer fit of the protective cover to the book. The protective cover is adjustable for book width by forming it of a primary or outside panel that is scored for separation of a back cover portion which may be adjustably positioned and adhesively secured to a front cover portion.

Pugliese et al., U.S. Pat. Nos. 4,893,837 and 5,004,514, disclose a protective book covering including a relatively long piece of sheet material and a relatively short piece of sheet material overlaying the long piece, the longitudinal edges of the two sheets being sealed together. A seal and tear line extending transverse to their longitudinal edges joins the two pieces and forms a line of severance along which the pieces can be torn to produce two units, each unit having a pocket adjacent to the seal and tear line for accommodating one of the covers of a book. One of the units has a section, extending from the pocket of that unit, long enough to wrap around the spine of the book, and be secured to the other unit. The sheet material is preferably transparent plastic. The book covering can be made in a continuous manner by providing independent lengths of relatively wide and relatively narrow plastic sheet material, and placing the lengths in face-to-face contact so that their longitudinal axes extend in the same direction. The two lengths are heat sealed together along a line parallel to their longitudinal axes but spaced from their longitudinal edges, and both lengths are heat sealed together and severed along lines transverse to their longitudinal axes. A strip of adhesive may be applied along one longitudinal edge of the wide length of material.

Ostrowski, U.S. Pat. No. 5,056,663, discloses an adjustable book cover and method wherein the book cover comprises a generally rectangular protective cover material wherein the length of the cover material may be easily adjusted through the use of releasable hook and loop fasteners or adhesive material and wherein the length of the material to fit the book to be protected is adjusted and pockets for the insertion of the book covers in said pockets by the employment of hook and loop fastener straps or adhesive material secured by elastic tabs to the cover material. The method includes providing a rectangular book cover material and folding over the top and bottom edges and securing the edges in place by the use of hook and loop fabric fasteners or an adhesive strip and forming side pockets for insertion of the book covers at each side edge thereof and folding over the side edges and securing the side edges by hook and loop fasteners or adhesive strips, particularly where such fasteners or strips at the side edges are tensioned by the use of elastic material.

Rajeswaran, U.S. Pat. No. 5,472,237, discloses an adjustable book cover that includes a pair of panels which are joined together to form a flat tubular member of extended length. A relatively narrow adhesive layer is deposited proximate to each of the longitudinal edges of the panels. A narrow strip of release film is positioned on each of the adhesive layers. The tubular member, which may be stored as a roll or in flat form, is cut to an appropriate length sufficient to cover the width of the book plus an amount sufficient to securely engage the book cover. The tubular member is then folded along its longitudinal edges to accommodate the height of the book. The release layers are removed and the adhesive layer maintains the width of the tubular member. The ends of the book covers are inserted into the ends of the tubular member and the adjustable book cover is mounted on the book in a secure manner.

Geddes, U.S. Pat. No. 6,419,274, discloses a book covering having a transparent front sheet and overlapping upper and lower rear sheets which can be secured together by means of an adhesive strip. In an alternative embodiment, one of the rear sheets may be omitted and the adhesive applied to the upper edge of the transparent front sheet. That sheet may then be folded over by the required amount, according to the size of book to be covered, and secured to the rear sheet.

The related art described above discloses various types of book coverings using adhesives, pockets, and straps to attach to the original cover of a book. However, the prior art fails to disclose a removably securable protective sheet providing opposing side flaps having adhesive strips enabling the cover to adhere to the inside surfaces of front and back covers of a paperback book, as well as an additional adhesive strip that engages with the spine of the paperback book. The present invention uses a minimum number of panels that are pre-scored to tightly fit a standard size paperback type book. This disclosure distinguishes over the prior art providing heretofore unknown advantages as described in the following summary.

### BRIEF SUMMARY OF THE INVENTION

This disclosure teaches certain benefits in construction and use which give rise to the objectives described below.

Protective book coverings for books are well known. However, as stated above, the prior art fails to disclose a removably securable protective covering having opposing side flaps that engage and adhere to the inside cover of a paperback type book, as well as an additional adhesive portion that engages with the spine of the paperback book. The present invention discloses such a protective covering for a paperback type book that is made up of a generally rectangular, foldable, protective sheet divided into a plurality of linearly adjoining panels. These panels include a front flap panel, a front cover panel, a spine panel, a back cover panel, and a back flap panel. Preferably the panels are separated by score lines, allowing the invention to be adjusted to fit a range of paperback book sizes. Adhesive portions are engaged with both flap panels as well as the spine panel, with each adhesive portion preferably providing a low-tack, reusable adhesive that enables the invention to be easily attached and removed without leaving marks or residue on the book. Thus, the present invention provides a relatively simple book covering for paperback books that is both cost-efficient and easy to use.

It is cost effective because it is made of less material stock compared to the prior art book coverings, and because it can be stamped into a finished product from a parent roll of stock in a single action. No subsequent folding or forming need be conducted. The commercially ready product is small enough to be inventoried and placed for sale in stacks that are store shelf efficient. Placement of the invention onto a paperback type book is made easy by folding line scores allowing so that the invention is quickly placed around a paperback type book quickly and providing the book with the appearance of a finished product. Because of this, the invention is ideal for use in disguising the nature of the covered book by providing cover indicia that is contrary to that of the covered book.

It should be noted that front and rear covers of a standard paperback book are, by their method of manufacture, not able to open and lay flat against a surface, such as a table, in the way that a hardback book is able to do. Thus, creating a tight engagement between a standard paperback book and a prior art protective covering can be quite difficult. Thus providing a plurality of score lines allows the present protective covering to tightly fit a wide range of paperback book sizes, as discussed below.

A primary objective inherent in the above described apparatus and method of use is to provide advantages not taught by the prior art.

Another objective is to provide a protective book covering for a paperback book that is able to be produced at a relatively low cost.

A further objective is to provide such an apparatus that can be used on paperback books of varying thicknesses.

A still further objective is to provide such an apparatus that can be removably secured to a paperback book with relative ease.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the present invention, a book cover;

FIG. 2 is a perspective view showing placement of a book onto the book cover;

FIG. 3 is a perspective view showing initial engagement of the book cover with the book;

FIG. 4 is a perspective view showing final engagement of the book cover with the book;

FIG. 5 is a sectional view taken along line 5-5 in FIG. 2;

FIG. 6 is a sectional view taken along line 6-6 in FIG. 2; and

FIG. 7 is a broken sectional view taken along line 7-7 in FIG. 4.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

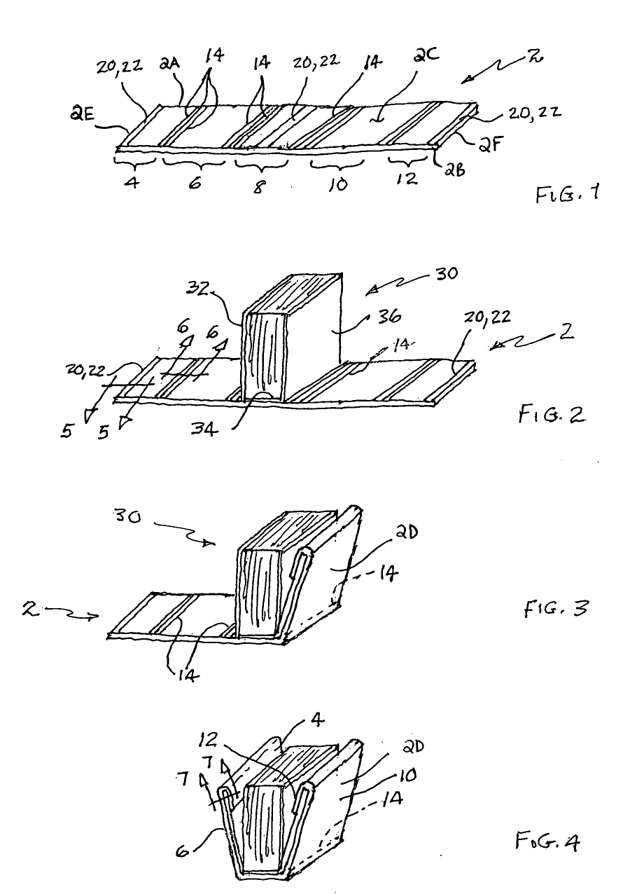

Described now in detail is a protective covering particularly adapted for a paperback type book, herein referred to simply as a book 30. As shown in FIG. 1, the covering 2 is a rectangular sheet divided into a plurality of rectangular adjoining panels by score lines 14. These panels include a front flap panel 4, a front cover panel 6, a spine panel 8, a rear cover panel 10, and a rear flap panel 12. Preferably, the covering 2 is made of paper, plastic, paper with a plastic coating, or plastic impregnated paper. However, other materials may be substituted as long as such material has a thickness and quality roughly similar to the covers found on paperback type books. The material must be flexible and easily folded, and once folded, it must hold its folds without an excessive tendency to unfold.

As shown in FIG. 1, each one of the adjacent panels 4, 6, 8, 10 and 12 is separated by one or more of the score lines 14, enabling selective folding of the covering 2. Shown in detail in FIG. 6, each one of the score lines 14 is cut or pressed into an inside surface 2C of the covering 2. Such scoring of paper, cardboard and plastic sheet stocks is well known in the art. Having a plurality of score lines 14 enables the width of each of the panels 4, 6, 8, 10 and 12 to be adjustable so as to conform to the size of a book to which the covering 2 is secured.

As shown in FIG. 1, a first adhesive portion 20 is engaged with an inside surface 2C of the covering 2 at the front flap panel 4 proximate to a left edge 2E of the covering 2 and a second adhesive portion 20 is engaged with the inside surface 2C of the covering 2 at the back flap panel 12 proximate to a right edge 2F of the covering 2. Preferably, a third adhesive portion 20 is engaged with the inside surface 2C of the covering 2 at the spine panel 8 as well. Each one of the adhesive portions 20 preferably extends between a top edge 2A and an opposing bottom edge 2B of the covering 2 and is initially covered by a removable cover portion 22, as best shown in FIG. 5. The adhesive portions 20 may alternately extend over only a portion of the distance between edges 2A and 2B. Preferably the adhesive is a low-tack, reusable adhesive that enables each one of the adhesive portions 20 to be easily attached and removed without leaving marks or residue. However, any other type of adhesive, or other means of attaching a the protective cover to a book may be used and may equally fulfill the objectives of the present invention.

The covering 2 is preferably used in the following way. First, as shown in FIG. 1, an outside surface 2D of the covering 2 is laid on and supported by a flat surface, such as a table top. Next, the removable cover portion 22 covering the spine panel 8 is removed, revealing adhesive portion 20, and book 30 is placed on the inside surface 2C with a spine 34 of the book 30 in contact with the exposed adhesive strip 20 of spine panel 8, as shown in FIG. 2. The book 30 remains in a position perpendicular to the inside surface 2C throughout the process. Next, the front and rear cover panels 6 and 10 are folded away from the flat surface so as to determine where the front and rear cover panels 6 and 10 should be folded relative to the spine panel 8. A proper set of score lines 14 relative to the spine panel 8 are chosen in order to fold the front and rear cover panels 6 and 10 to create a tight engagement between a front cover 32 and rear cover 36 of the book 30 respectively.

Next, the front and rear flap panels 4 and 12 are folded along the appropriate score lines 14 over left and right edges of the front and rear covers 32 and 36 of the book 30 respectively. The appropriate score lines 14 used in folding each one of the front and rear flap panels 4 and 12 is determined by the score lines 14 initially selected in folding each one of the front and rear cover panels 6 and 10 relative to the spine panel 8. In other words, the thickness and width of the book 30 determine the appropriate score lines 14 to use in order to create a tight engagement between the covering 2 and the book 30.

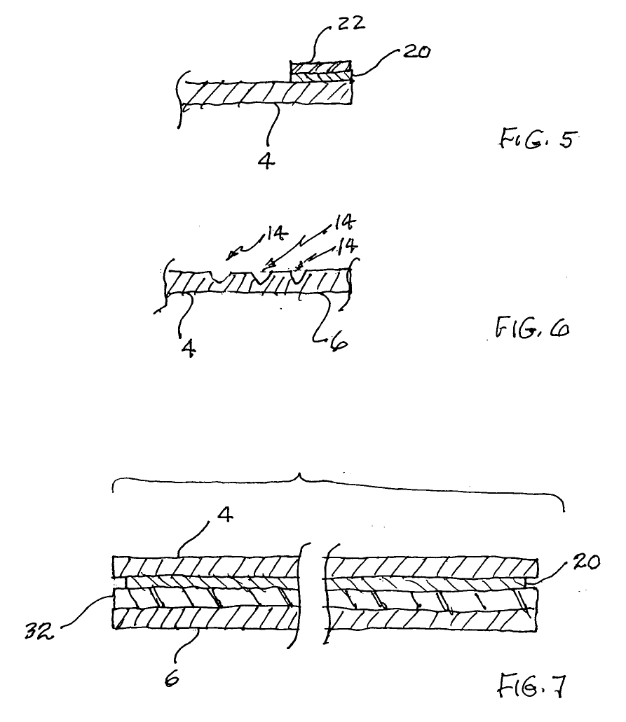

The adhesive portions 20 on the front and rear flap panels 4 and 12 are exposed by removing the removable cover portions 22, and the flap panels 4 and 12 are then folded into contact with inside surfaces of the front and rear covers 32 and 36 of the book 30 and adhered thereto, as partially shown in FIGS. 3 and 7. The book 30 is now fully covered, as shown in FIG. 4, and is disguised by the indicia on the outside surface of the covering 2. Of course the outside surface 2D of the covering 2 may be blank; in which case the identity of the covered book 30 is not visible.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A protective covering for a paperback book, the book having a front cover, a rear cover, and a spine joining the front and rear covers, the protective covering comprising:
a rectangular sheet having a top edge and an opposing bottom edge, a left and a right edge, an inside surface and an outside surface, the sheet divided into a linear sequence of rectangular panels by score lines, the sequence including, in order: a front flap panel, a front cover panel, a spine panel, a rear cover panel, and a rear flap panel; and
an adhesive portion disposed on the inside surface of the sheet at each of the front flap panel and the rear flap panel;
whereby the sheet is securable to an outer surface of a front cover and rear cover of the book.

2. The apparatus of claim 1 wherein an adhesive portion is disposed on the inside surface of the sheet at the spine panel;

3. The apparatus of claim 2 wherein each one of the adhesive portions is covered by a removable cover portion.

4. The apparatus of claim 1 wherein each one of the adhesive portions on the front and rear flap panels extends between the top edge and bottom edge of the sheet and approximately in parallel alignment with the left and right edges of the sheet, and proximate to the left and right edges respectively.

5. The apparatus of claim 2 wherein the adhesive portion on the spine panel extends between the top edge and bottom edge of the sheet.

6. The apparatus of claim 1 wherein the sheet material is at least one of: paper, plastic, paper with plastic coating, or plastic impregnated paper.

7. The apparatus of claim 1 wherein each pair of the adjoining panels are separated by a plurality of score lines enabling selective folding of the covering.

8. A paperback book having a removable protective covering, the book having a front cover, a rear cover, and a spine joining the front and rear covers, and the protective covering comprising:
a rectangular sheet having a top edge and an opposing bottom edge, a left and a right edge, an inside surface and an outside surface, the sheet divided into a linear sequence of rectangular panels by score lines, the sequence including, in order: a front flap panel, a front cover panel, a spine panel, a rear cover panel, and a rear flap panel; and
an adhesive portion disposed on the inside surface of the sheet at each of the front flap panel, rear flap panel, and spine panel;
whereby the sheet is securable to an outer surface of the front cover, rear cover, and spine of the book.

9. The apparatus of claim 8 wherein each one of the adhesive portions is covered by a removable cover portion.

10. The apparatus of claim 8 wherein each one of the adhesive portions on the front and rear flap panels extends between the top edge and bottom edge of the sheet and approximately in parallel alignment with the left and right edges of the sheet, and proximate to the left and right edges respectively.

12. The apparatus of claim 8 wherein the adhesive portion on the spine panel extends between the top edge and bottom edge of the sheet.

13. The apparatus of claim 8 wherein the sheet material is at least one of: paper, plastic, paper with plastic coating, or plastic impregnated paper.

14. The apparatus of claim 8 wherein each pair of the adjoining panels are separated by a plurality of score lines enabling selective folding of the covering.

15. A method of removably securing a covering on a paperback book, the book having a front cover, a rear cover, and a spine, the method comprising the steps of:
positioning the covering on a flat surface with an inside surface of the covering facing away from the flat surface;
dividing the covering into a plurality of rectangular adjoining panels, each pair of the adjoining panels separated by a plurality of score lines enabling selective folding of said covering;
placing the spine of the paperback book into contact with a spine panel of the adjoining panels of the covering;
folding the front and rear cover panels along score lines relative to the spine panel thereby enabling a tight engagement between the front and rear covers of the book respectively;
folding a front flap panel and a rear flap panel along appropriate score lines over left and right edges of the front and rear covers of the book respectively; the appropriate score lines used in folding the flap panels determined by the score lines selected in folding the covers relative to the spine; and
engaging an adhesive portion of each one of the front and rear flap panels with an inside surface of the front and rear covers of the book respectively.

16. The method of claim 15 further comprising the step of engaging an adhesive portion on the spine panel with the spine of the book.

17. The method of claim 15 further comprising the step of removing a removable cover portion covering each one of the adhesive portions.
